(19) United States
(12) Patent Application Publication
(10) Pub. No.: US 2023/0304467 A1
(43) Pub. Date: Sep. 28, 2023

(54) FLUID ACCELERATION SYSTEM

(71) Applicant: DUPLICENT, LLC, Santa Monica, CA (US)

(72) Inventor: Curren Emmett Krasnoff, Santa Monica, CA (US)

(21) Appl. No.: 17/822,981

(22) Filed: Aug. 29, 2022

Related U.S. Application Data
(63) Continuation of application No. PCT/US2021/027875, filed on Apr. 19, 2021.
(60) Provisional application No. 63/146,620, filed on Feb. 6, 2021.
(60) Provisional application No. 63/015,363, filed on Apr. 24, 2020.

(51) Int. Cl. F03B 17/06; H02K 7/18; B01F 25/52; B01F 27/2122; B01F 27/191; B01F 27/112; B01F 27/90

(52) U.S. Cl. CPC F03B 17/06; H02K 7/1823; B01F 25/52; B01F 27/2122; B01F 27/191; B01F 27/112; B01F 27/90

(57) ABSTRACT

A fluid acceleration system includes a housing, a rotational element, a conduit assembly, and a driver. The housing defines an inlet, an outlet, and an interior chamber configured to receive a fluid. The rotational element is disposed within the interior chamber. The rotational element includes a central support and a plurality of blades coupled to the central support. The central support extends between an upper wall and a lower wall of the housing. The conduit assembly is positioned external to the housing. The conduit assembly connects the outlet to the inlet. The driver is positioned to drive the rotational element to accelerate the fluid within the interior chamber such that a portion of the fluid flows out of the outlet, through the conduit assembly, and back into the interior chamber through the inlet.

### CROSS-REFERENCE TO RELATED APPLICATION

ROW This application is a continuation of International Patent Application No. PCT/US2021/027875, filed Apr. 19, 2021, which claims the benefit of and priority to U.S. Provisional Patent Application No. 63/015,363, filed Apr. 24, 2020, and U.S. Provisional Patent Application No. 63/146,620, filed Feb. 6, 2021, all of which are incorporated herein by reference in their entireties.

### BACKGROUND

Turbines may be driven by a fluid (e.g., gas, liquid) to generate electricity. Such electricity can be used to charge batteries, power electronic devices, or supply the grid.

### SUMMARY

One embodiment relates to a fluid acceleration system. The fluid acceleration system includes a housing, a rotational element, a conduit assembly, and a driver. The housing defines an inlet, an outlet, and an interior chamber configured to receive a fluid. The rotational element is disposed within the interior chamber. The rotational element includes a central support and a plurality of blades coupled to the central support. The central support extends between an upper wall and a lower wall of the housing. The conduit assembly is positioned external to the housing. The conduit assembly connects the outlet to the inlet. The driver is positioned to drive the rotational element to accelerate the fluid within the interior chamber such that a portion of the fluid flows out of the outlet, through the conduit assembly, and back into the interior chamber through the inlet.

In some embodiments, the housing defines a plurality of inlets connected to the conduit assembly.

In some embodiments, the central support aligns with the inlet and defines an internal support channel that receives the fluid from the conduit assembly.

In some embodiments, the central support defines a support aperture configured to release the fluid into the interior chamber.

In some embodiments, the central support defines a plurality of support apertures.

In some embodiments, the plurality of apertures are positioned proximate one end of the central support.

In some embodiments, the plurality of apertures are spaced along at least a portion of a length of the central support.

In some embodiments, at least one of the plurality of blades defines an internal blade channel that receives the fluid from the internal support channel of the central support, and wherein the at least one of the plurality of blades defines a blade aperture this is configured to release the fluid into the interior chamber.

In some embodiments, the blade aperture is positioned proximate a free end of the at least one of the plurality of blades.

In some embodiments, the blade aperture is positioned proximate a connection between the central support and the at least one of the plurality of blades.

In some embodiments, the at least one of the plurality of blades defines a plurality of blade apertures.

In some embodiments, the central support has a cylindrical shape.

In some embodiments, the central support has a conical shape.

In some embodiments, the central support and the plurality of blades have a spiral structure or a helical structure.

In some embodiments, the fluid acceleration system includes a door positioned to selectively close the outlet of the housing.

In some embodiments, the fluid acceleration system includes a fluid scoop coupled to the housing proximate the outlet, the fluid scoop positioned to direct the portion of the fluid from the interior chamber, through the outlet, and into the conduit assembly.

In some embodiments, the fluid acceleration system includes a generator positioned along the conduit assembly and that receives the portion of the fluid.

In some embodiments, the fluid acceleration system includes a battery coupled to the generator.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a schematic diagram of a fluid acceleration system, according to an exemplary embodiment.

FIG. 2 is a detailed cross-sectional view of a fluid acceleration assembly of the fluid acceleration system of FIG. 1, according to an exemplary embodiment.

FIG. 3 is a detailed cross-section view of the fluid acceleration assembly of FIG. 2, according to another exemplary embodiment.

FIG. 4 is a detailed cross-section view of the fluid acceleration assembly of FIG. 2, according to another exemplary embodiment.

FIG. 5 is a detailed cross-section view of the fluid acceleration assembly of FIG. 2, according to another exemplary embodiment.

FIG. 6 is a detailed cross-section view of the fluid acceleration assembly of FIG. 2, according to another exemplary embodiment.

FIG. 7 is a schematic diagram of a control system of the fluid acceleration system of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a fluid acceleration system of the present disclosure includes a housing defining a chamber, a rotational element disposed within the chamber, a rotational actuator configured to drive the rotational element, and a generator fluidly coupled to the housing. The chamber receives a fluid (e.g., a gas, a liquid, etc.). The rotational element is configured to accelerate the fluid within and drive the fluid around the chamber. As the fluid is driven within the chamber, a portion the fluid is diverted from the chamber and through the generator to generate electricity. The portion of the fluid may then be returned to the chamber where it is mixed in with the remainder of the fluid and reaccelerated.

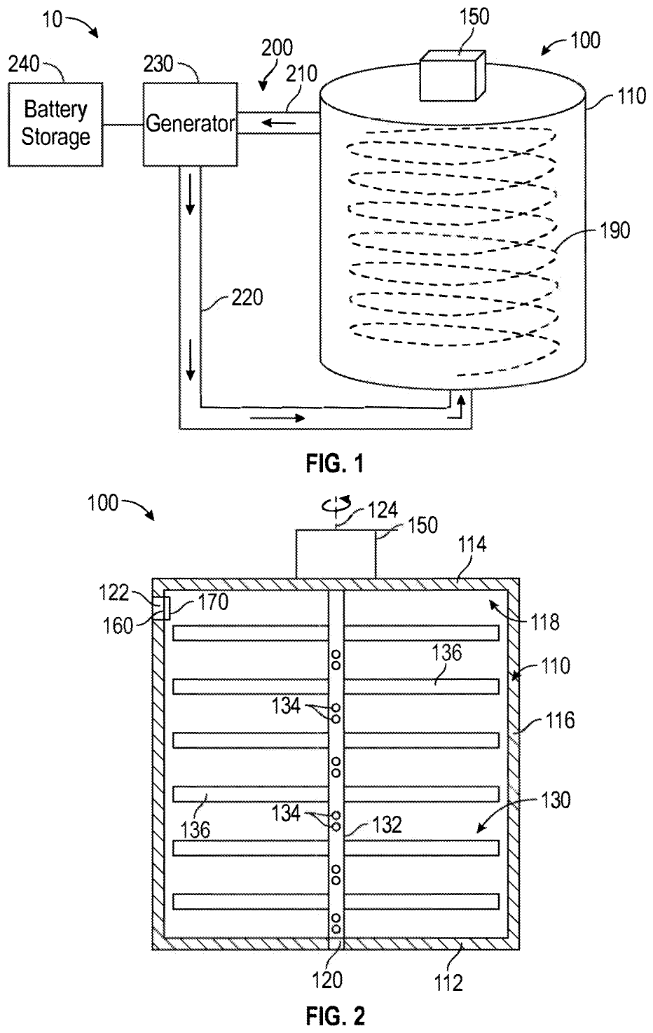

According to the exemplary embodiment shown in FIG. 1, an acceleration system, shown as fluid acceleration system 10, includes an acceleration assembly, shown as fluid acceleration assembly 100; a conduit assembly, shown as a conduit assembly 200, including a first conduit, shown as exhaust conduit 210, and a second conduit, shown as return conduit 220; a generation device, shown as generator 230, positioned along the conduit assembly 200 with (i) the exhaust conduit 210 connecting an outlet of the fluid acceleration assembly 100 to an inlet of the generator 230 and (ii) the return conduit 220 connecting an outlet of the generator 230 to an inlet of the fluid acceleration assembly 100; and an energy storage system, shown as battery storage 240, coupled to the generator 230. According to the exemplary embodiment, the generator 230 is a turbine (e.g., a fluid-driven turbine, a gas-driven turbine, a steam turbine, a liquid driven turbine, a hydro-turbine etc.). In some embodiments, the fluid acceleration system 10 does not include the generator 230 and/or the battery storage 240.

As shown in FIGS. 1-6, the fluid acceleration assembly 100 includes a housing, shown as accelerator housing 110. According to the exemplary embodiment shown in FIGS. 1-6, the accelerator housing 110 has a cylindrical structure or shape. In other embodiments, the accelerator housing 110 has a spherical structure or shape, a conical structure or shape, and/or still another suitable structure or shape. According to various embodiments, the accelerator housing 110 has a height between 1 foot and 500 feet (e.g., 1, 2, 3, 5, 10, 15, 20, 25, 50, 75, 100, 125, 150, 175, 200, 225, 250, 275, 300, 350, 400, 450, 500, etc. feet). According to various embodiments, the accelerator housing 110 has a width or diameter between 1 foot and 300 feet (e.g., 1, 2, 3, 5, 10, 15, 20, 25, 50, 75, 100, 125, 150, 175, 200, 250, 300, etc. feet).

As shown in FIGS. 2-6, the accelerator housing 110 include a first wall, shown as bottom wall 112, an opposing second wall, shown as top wall 114, and a peripheral sidewall, shown as sidewall 116, extending between and around the peripheries of the bottom wall 112 and the top wall 114. The bottom wall 112, the top wall 114, and the sidewall 116 cooperatively define an interior chamber, shown as fluid acceleration chamber 118.

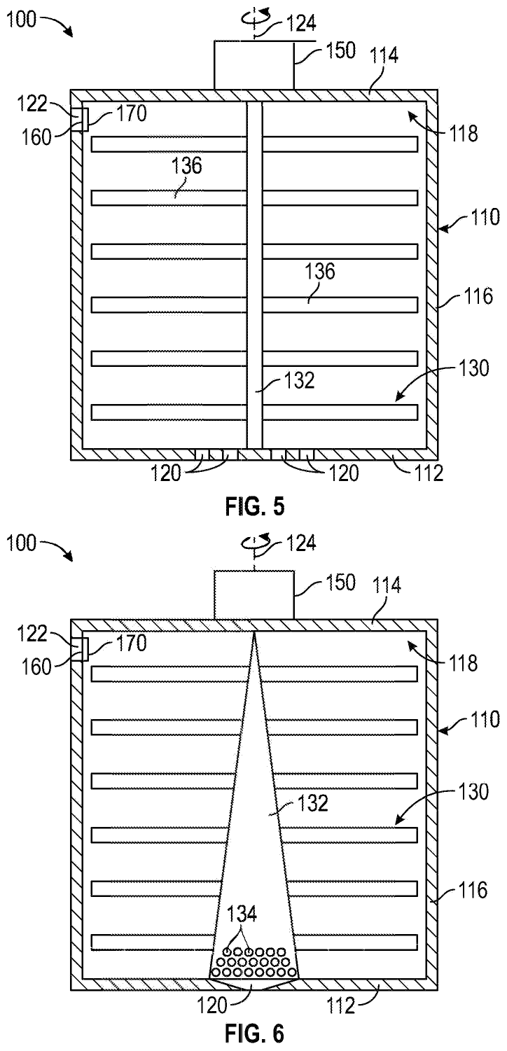

As shown in FIGS. 2-4 and 6, the bottom wall 112 defines a first aperture, shown as housing inlet 120. As shown in FIG. 5, the bottom wall 112 defines a plurality of the housing inlets 120. In other embodiments, the top wall 114 additionally or alternatively defines one or more housing inlets 120. In still other embodiment, the sidewall 116 additionally or alternatively defines one or more housing inlets 120.

As shown in FIGS. 2-6, the sidewall 116 defines a second aperture, shown as housing outlet 122, at a top end thereof, proximate the top wall 114. In another embodiment, the housing outlet 122 is positioned at a bottom end of the sidewall 116, proximate the bottom wall 112. In some embodiments, the sidewall 116 defines a plurality of the housing outlets 122 positioned at various locations along the accelerator housing 110 (e.g., along a vertical line along at least a portion of the height of the accelerator housing 110; in a horizontal, peripheral line around the periphery of the accelerator housing 110; around the accelerator housing 110 in a spiral shape; etc.). In other embodiments, the top wall 114 additionally or alternatively defines one or more of housing outlets 122. In still other embodiment, the bottom wall 112 additionally or alternatively defines one or more of housing outlets 122. It should be understood that the disclosure herein relating to the housing outlet(s) 122 may be similarly applied to the housing inlet(s) 120, and vice versa. The fluid acceleration chamber 118 may be substantially sealed and airtight other than the housing inlet(s) 120 and the housing outlet(s) 122.

As shown in FIGS. 2-6, the fluid acceleration assembly 100 includes a rotational element, shown as accelerator 130, disposed within the fluid acceleration chamber 118. The accelerator 130 includes (i) a support element or center enclosure, shown as central support 132, extending between the bottom wall 112 and the top wall 114 and (ii) a plurality of fan-like or blade-like elements, shown as blades 136, extending radially outward from the central support 132. In other embodiments, the blades 136 extend inwardly from the interior surface of the sidewall 116 of the accelerator housing 110. In still other embodiments, the blades 136 extend inwardly from an interior surface of the top wall 114 and/or the bottom wall 112 around the circumference of the accelerator housing 110. As shown in FIGS. 2-5, the central support 132 has a cylindrical shape. As shown in FIG. 6, the central support 132 has a conical shape. In other embodiments, the central support 132 has another suitable shape. As shown in FIGS. 2-6, the accelerator housing 110 defines a central axis, shown as vertical axis 124, along which the central support 132 is disposed.

In one embodiment, the central support 132 has a solid structure. In another embodiment, the central support 132 has a hollow structure and defines an internal support channel, cavity, or enclosure. In still another, the central support 132 is a frame structure that is open to the fluid acceleration chamber 118. In embodiments where the central support 132 has a hollow structure, as shown in FIGS. 2 and 6, the central support 132 defines one or more support apertures, shown as support outlets 134. As shown in FIG. 2, the support outlets 134 are spaced along at least a portion of a length of the central support 132. As shown in FIG. 6, the support outlets 134 are positioned proximate the bottom end of the central support 132. In another embodiment, the support outlets 134 are additionally or alternatively positioned proximate the top end of the central support 132.

As shown in FIGS. 2-6, the blades 136 are spaced along the length of the central support 132 at a plurality of levels. The blades 136 extend radially outward from the central support 132 toward the sidewall 116 such that the free ends of the blades 136 are positioned proximate an interior surface of the sidewall 116. In one embodiment, the plurality of levels of the blades 136 are spaced uniformly along the length of the central support 132. In another embodiment, the plurality of levels of the blades 136 are spaced non-uniformly along the length of the central support 132 (e.g., the levels of the blades 136 positioned proximate the bottom end of the central support 132 are closer together than the levels of the blades 136 positioned proximate the top end of the central support 132, etc.).

According to the exemplary embodiment shown in FIGS. 2-5, the length of the blades 136 have a uniform length along the central support 132 such that the free ends of the blades 136 are spaced the same distance from the interior surface of the sidewall 116. In other embodiments, the length of the blades 136 varies along the length of the central support 132 (e.g., such that the free ends of the blades 136 at different levels are spaced a different distance from the interior surface of the sidewall 116, to accommodate an accelerator housing 110 with an angled, tapered, or curved sidewall 116, etc.). As shown in FIG. 6, the length of the blades 136 varies along the length of the central support 132, but the free ends of the blades 136 are spaced the same distance from the interior surface of the sidewall 116. In some embodiments, the length of the blades 136 is adjustable.

In one embodiment, each level of the blades 136 includes two of the blades 136 extending in opposing directions from the central support 132. In another embodiment, each level of the blades 136 includes a single blade 136 (e.g., arranged in a stepped-spiral shape around the central support 132, that extends outward in one direction, that extends through the central support 132 and extends in opposing directions, etc.). In still another embodiment, each level of the blades 136 includes three or more blades 136 (e.g., three, four, five, etc. blades). In yet another embodiment, the number of the blades 136 at each level along the central support 132 varies (e.g., increases from bottom to top, decreases from bottom to top, alternates each level between a first number of blades and a second number of blades, etc.).

In some embodiments, each level of the blades 136 is offset from the level of the blades 136 above and below such that the blades 136 are oriented at different angles about the central support 132. For example, (i) the blades 136 of a first level may be oriented in various first directions with gaps between the blades 136 of the first level and (ii) the blades 136 of a second level may be oriented in various second directions that align with the gaps between the blades 136 of the first level.

In some embodiments, the blades 136 are angled relative to a longitudinal axis thereof (e.g., a leading edge of the blades 136 is offset from (lower or higher than) a trailing edge of the blades 136, etc.) to drive fluid within the fluid acceleration chamber 118 in a preselected direction. In one embodiment, the angle of the blades 136 is adjustable. According to an exemplary embodiment, the blades 136 have a curved or non-uniform profile such that the shape of the blades 136 vary from the ends connected to the central support 132 to the free ends thereof. The profile of the blades 136 in one level may vary from the profile of the blades 136 in another level.

In an alternative embodiment, the central support 132 and the blades 136 have a structure that forms a spiral structure or a helical structure. The spiral structure or the helical structure may have a uniform width or diameter along the height thereof or may taper inward or outward from top to bottom.

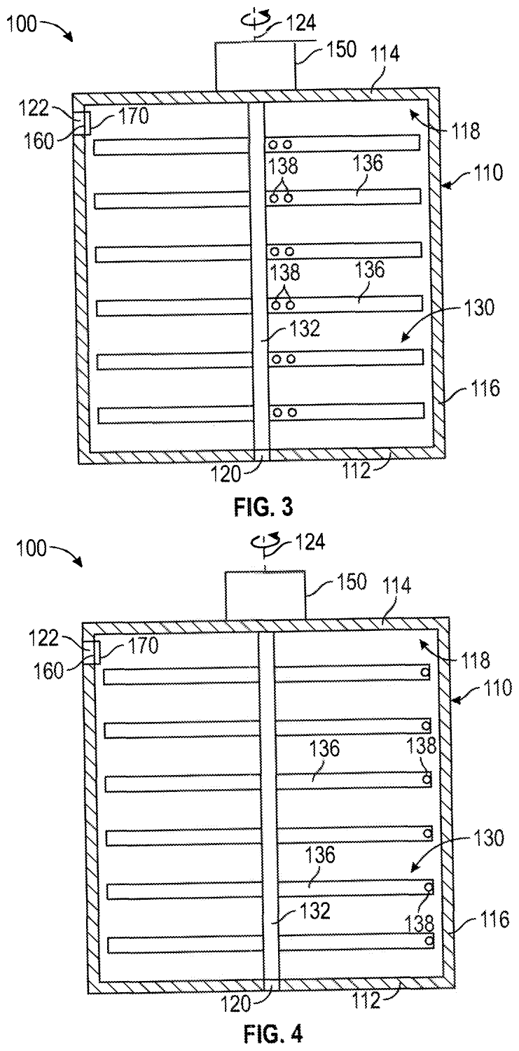

In one embodiment, the blades 136 have a solid structure. In another embodiment, at least one of the blades 136 has a hollow structure and defines an internal blade channel. In embodiments where the central support 132 has a hollow structure, the internal blade channel connects to the internal support channel of the central support 132 and, as shown in FIGS. 3 and 4, the at least one blade 136 defines one or more blade apertures, shown as blade outlets 138. The blade outlets 138 may extend along at least a portion of the at least one blade 136. As shown in FIG. 3, the blade outlet(s) 138 is/are positioned proximate a connection between the central support 132 and the at least one blade 136 (i.e., the proximal end of the blade 136). As shown in FIG. 4, the blade outlet(s) 138 is/are positioned proximate the free end of the at least one blade 136 (i.e., the distal end of the blade 136). In some embodiments, the central support 132 defines the support outlet(s) 134 and at least one of the blades 136 define the blades outlet(s) 138.

As shown in FIGS. 1-6, the fluid acceleration assembly 100 include a rotational actuator, shown as driver 150. According to the exemplary embodiment shown in FIGS. 1-6, the driver 150 is positioned along the top wall 114, external to the fluid acceleration chamber 118. In another embodiment, the driver 150 is positioned within the fluid acceleration chamber 118. According to an exemplary embodiment, the driver 150 is positioned to rotate the central support 132 and, thereby, the blades 136 within the fluid acceleration chamber 118 and about the vertical axis 124, In one embodiment, the driver 150 is an electric motor. In another embodiment, the driver 150 is an internal combustion engine (e.g., a spark-ignition engine, a compression-ignition engine, etc.), In still another embodiment, the driver 150 is a hybrid driver that includes (i) an internal combustion engine and an electric motor that are separately operable or (ii) a generator (e.g., a combustion generator, a solar generator, etc.) and a motor driven by electricity generated by the generator. In yet another embodiment, the driver 150 include a hydraulically-driven motor and a hydraulic pump.

In some embodiments, the fluid acceleration assembly 100 includes a plurality of drivers 150. Each of the plurality of drivers 150 may be connected to a subset (e.g., one or more levels, etc.) of the blades 136 of the accelerator 130. The plurality of drivers 150 may accelerate in sequence like gears. There may be different sized blades 136 attached to each of the plurality of drivers 150, Smaller, more narrow blades 136 may be driven first, then when sufficiently accelerated, thicker blades 136 may be driven in addition to or in place of the narrow blades 136. This may happen at various levels, for example, between 1 to 20 or more levels. Blades 136 of different sizes may be stored outside the accelerator housing 110 when not in use. The blades 136 may be removed from the accelerator housing 110 in series when not used. There may be a changeover or transition sequence where there are two different sizes of blades 136 that spin at least partially together in the fluid acceleration chamber 118 at the same time. Alternatively, one driver 150 may be configured to switch between the different sized blades 136. There may be a maintenance phase of the acceleration process where one or more blades 136 are removed after sufficiently accelerating the fluid 190, then the one or more blades 136 can be added back to continue accelerating (e.g., to conserve power consumption, etc.). A lower level blade 136 may be added back after the maintenance period. The blades 136 may also spin freely without power during the maintenance period. In another embodiment, instead of having multiple sized blades 136, one or more blades 136 may change size mechanically. For example, the one or more blades 136 may be configured to retract and/or extend inward and outward from the central support 132 (e.g., via blade actuators, etc.). In addition, the orientation of the blades 136 may be adjusted (e.g., via blade actuators, etc.) between a position where the blades are substantially horizontal or flat (e.g., to provide less resistance when beginning to spin, etc.) and then rotate more vertical to accelerate more of the fluid 190.

As shown in FIGS. 2-6, the fluid acceleration assembly 100 includes a door, shown as outlet door 160, positioned to facilitate selectively opening and closing the housing outlet 122. In some embodiments (e.g., embodiments where the accelerator housing 110 defines a plurality of the housing outlets 122, etc.), the fluid acceleration assembly 100 includes a plurality of the outlet doors 160. In some embodiments, the fluid acceleration assembly 100 does not include the outlet door 160. In such embodiments, the outlet door 160 may be replaced with a valve or other selective flow control device or mechanism.

As shown in FIGS. 2-6, the fluid acceleration assembly 100 includes a flow diverter, shown as fluid scoop 170, positioned within the fluid acceleration chamber 118 and proximate the housing outlet 122. According to an exemplary embodiment, the fluid scoop 170 extends inward from the sidewall 116 of the accelerator housing 110. In one embodiment, the fluid scoop 170 has a linear, angled profile. In another embodiment, the fluid scoop 170 has a curved profile. In some embodiments, the fluid acceleration assembly 100 does not include the fluid scoop 170. In some embodiments, the fluid scoop 170 is adjustable or retractable. For example, the fluid scoop 170 may be repositionable and move from a position flush with the sidewall 116 of the accelerator housing 110 to an extended position (e.g., via a scoop actuator, an electric actuator, a hydraulic actuator, a pneumatic actuator, etc.). In some embodiments (e.g., embodiments where the accelerator housing 110 defines a plurality of the housing outlets 122, etc.), the fluid acceleration assembly 100 includes a plurality of the fluid scoops 170.

As shown in FIG. 1, the accelerator housing 110 (i.e., the fluid acceleration chamber 118 of the accelerator housing 110) is configured to receive a working fluid, shown as fluid 190, In some embodiments, the fluid 190 is a gas. In one embodiment, the gas is air. In another embodiment, the gas is nitrogen. In still another embodiment, the gas is a heavy gas (i.e., heavier than air) such as argon, etc. In yet another embodiment, the gas is an inert gas. In some embodiments, the fluid 190 is a liquid (e.g., water, ethylene glycol, mercury, etc.).

According to an exemplary embodiment, the driver 150 is configured to drive (i.e., rotate) the accelerator 130 to cause the fluid 190 within the fluid acceleration chamber 118 to accelerate and move around the fluid acceleration chamber 118 (e.g., at a high rate of speed). The driver 150 may be configured to drive the accelerator 130 at various speeds (e.g., 100 rpm; 1,000 rpm; 10,000 rpm; 100,000 rpm; etc.). As the fluid 190 moves around the fluid acceleration chamber 118, a portion of the fluid 190 may flow out of the housing outlet(s) 120 (e.g., if the outlet door 160 is open, when a speed threshold of the fluid 190 within the fluid acceleration chamber 118 is achieved, in a continuous stream if there is no door or other selective blocking or flow control mechanism, etc.) and into the exhaust conduit 210 of the conduit assembly 200.

According to an exemplary embodiment, the portion of the fluid 190 is a minor portion of the total volume of the fluid 190 within the fluid acceleration chamber 118 (e.g., a small portion, a negligible portion, less than 5% of the total volume of the fluid 190 within the fluid acceleration chamber 118, less than 1% of the total volume of the fluid 190 within the fluid acceleration chamber 118, etc.) such that the rotational momentum of the fluid 190 within the fluid acceleration chamber 118 is substantially maintained or conserved as the portion of the fluid 190 is removed or diverted from the fluid acceleration chamber 118. In embodiments where the fluid acceleration assembly 100 includes the fluid scoop 170, the fluid scoop 170 is configured (e.g., positioned, structured, etc.) to direct (e.g., divert, lead, etc.) the portion of the fluid 190 from the fluid acceleration chamber 118, through the housing outlet 122, and into the conduit assembly 200.

The portion of the fluid 190 then flows through the exhaust conduit 210 into the generator 230 to drive the generator 230 to generate electricity. In some embodiments, the length of the exhaust conduit 210 is minimized so as to provide the portion of the fluid 190 to the generator 230 with minimal speed losses. In one embodiment, the generator 230 is positioned along the top wall 114 of the accelerator housing 110. In another embodiment, the generator 230 is positioned proximate the bottom wall 112 of the accelerator housing 110 (e.g., on the ground beside the accelerator housing 110, on a platform adjacent the accelerator housing 110, etc.). In other embodiments, the conduit assembly 200 does not include the exhaust conduit 210. Rather, the generator 230 is directly coupled to an exterior of the accelerator housing 110 over the housing outlet 122 (e.g., the sidewall 116 if the housing outlet 122 is defined by the sidewall 116, the top wall 114 if the housing outlet 122 is defined by the top wall 114, the bottom wall 112 if the housing outlet 122 is defined by the bottom wall 112, etc.). Stated another way, there may be one or more housing outlets 122 that lead to one or more generators 230 around the circumference of the accelerator housing 110, on the sidewall 116 of the accelerator housing 110, on the top wall 114 of the accelerator housing 110, and/or on the bottom wall 112 of the accelerator housing 110.

After the portion of the fluid 190 flows through the generator 230, the portion of the fluid 190 flows from the generator 230 into the return conduit 220 and through the return conduit 220 to the housing inlet(s) 120. The portion of the fluid 190 is then reintroduced or fed back into the fluid acceleration chamber 118 and reaccelerated by the much larger volume of the fluid 190 moving about the fluid acceleration chamber 118. Again, because the portion of the fluid 190 flowing out of and back into the fluid acceleration chamber 118 is a minor portion of the total volume of the fluid 190, reintroducing the portion of the fluid 190 into the fluid acceleration chamber 118 may negligibly or minimally affect the rotational momentum of the fluid 190 within the fluid acceleration chamber 118 such that the rotational momentum of the fluid 190 is substantially maintained or conserved.

In some embodiments (e.g., in embodiments where the accelerator housing 110 defines a plurality of housing outlets 122, in embodiments where the fluid acceleration system 10 include a plurality of generators 230, etc.), the conduit assembly 200 includes a plurality of exhaust conduits 210. In one embodiment, each of the plurality of exhaust conduits 210 extends between a respective one of the plurality of housing outlets 122 and a single, common generator 230. In another embodiment, the fluid acceleration system 10 includes a plurality of generators 230 and each of the plurality of exhaust conduits 210 extends between a respective one of the plurality of housing outlets 122 and a respective one of the plurality of generators 230. In one embodiment (e.g., an embodiment where a plurality of the housing outlets 122 are arranged around the periphery of the accelerator housing 110, etc.), the plurality of generators 230 are arranged around the periphery of the accelerator housing 110. In another embodiment (e.g., an embodiment where a plurality of the housing outlets 122 are arranged vertically along the accelerator housing 110, etc.), the plurality of generators 230 are arranged vertically in series or in a stacked configuration. In some embodiments, a plurality of exhaust conduits 210 are coupled to a single housing outlet 122 and each of the plurality of exhaust conduits 210 is coupled to a respective one of the plurality of generators 230.

In some embodiments (e.g., in embodiments where the accelerator housing 110 defines a plurality of housing inlets 120, in embodiments where the fluid acceleration system 10 includes a plurality of generators 230, etc.), the conduit assembly 200 includes a plurality of return conduits 220. In one embodiment, each of the plurality of return conduits 220 extends between a respective one of the plurality of generators 230 and a common or single housing inlet 120. In another embodiment, the plurality of return conduits 220 extends from a single, common generator 230 and each of the plurality of return conduits 220 interfaces with a respective one of the plurality of housing inlets 120. In still another embodiment, each one of the plurality of return conduits 220 extends from a respective one of the plurality of generators 230 to a respective one of the plurality of housing inlets 120.

As shown in FIGS. 2 and 6, the central support 132 aligns with the housing inlet 120 and the central support 132 defines the support outlets 134. In such an arrangement, the portion of the fluid 190 is returned to the accelerator housing 110 through the housing inlet 120 (e.g., by a single return conduit 220, by a plurality of return conduits 220, etc.) and into the internal support channel of the central support 132. The portion of the fluid 190 may then flow out of the support outlets 134 of the central support 132 into the fluid acceleration chamber 118. In one embodiment, the support outlets 134 include one-way valves that allow the portion the fluid 190 within the internal support channel of the central support 132 to flow out of the support outlets 134, but prevents the fluid 190 within the fluid acceleration chamber 118 from flowing through the support outlets 134 into the internal support channel of the central support 132.

As shown in FIGS. 3 and 4, the central support 132 aligns with the housing inlet 120 and the blades 136 define the blade outlets 138. In such an arrangement, the portion of the fluid 190 is returned to the accelerator housing 110 through the housing inlet 120 (e.g., by a single return conduit 220, by a plurality of return conduits 220, etc.) and into the internal support channel of the central support 132. The portion of the fluid 190 may then flow from the internal support channel of the central support 132 into the internal channels of the blades 136 and out of the blade outlets 138 of the blades 136 into the fluid acceleration chamber 118. In one embodiment, the blade outlets 138 include one-way valves that allow the portion the fluid 190 within the internal blade channels of the blades 136 to flow out of the blade outlets 138, but prevent the fluid 190 within the fluid acceleration chamber 118 from flowing through the blade outlets 138 into the internal blade channels of the blades 136. In some embodiments, as shown in FIGS. 3 and 4, the blade outlets 138 are positioned along the trailing edge of the blades 136 such that the portion of the fluid 190 reintroduced into the fluid 190 enters the fluid acceleration chamber 118 from the blades 136 in direction opposite the direction of rotation of the accelerator 130.

As shown in FIG. 5, the accelerator housing 110 defines a plurality of the housing inlets 120, which do not align with the central support 132 (e.g., the central support 132 is solid and does not define the internal support channel, etc.). In another embodiment, the accelerator housing 110 defines a single housing inlet 120 that does not align with the central support 132. In such an arrangement, the portion of the fluid 190 is returned directly to the fluid acceleration chamber 118 of the accelerator housing 110 through the one or more housing inlets 120 (e.g., by a single return conduit 220, by a plurality of return conduits 220, etc.). In one embodiment, the one or more housing inlets 120 include one-way valves that allow the portion the fluid 190 to flow out of the one or more housing inlets 120 into the fluid acceleration chamber 118, but prevent the fluid 190 within the fluid acceleration chamber 118 from flowing through the one or more housing inlets 120 into the return conduit(s) 220.

While the accelerator 130 has been disclosed as being disposed along the vertical axis 124, in other embodiments, the accelerator 130 may be otherwise arranged, constructed, or positioned. By way of example, the accelerator 130 (i.e., the central support 132 and the blades 136) may be replaced with a plurality of fans or mixing elements that are positioned along the interior surface of the bottom wall 112 and/or the top wall 114 (e.g., around the periphery thereof, etc.). By way of another example, the central support 132 may remain, but the blades 136 may be replaced with a plurality of fans or mixing elements positioned along the interior surface of the sidewall 116. In such an arrangement, the housing outlet 122 may be positioned at an end of the central support 132 and connect to the internal support channel thereof. The plurality of fans or mixing elements may, therefore, push the fluid into and through the internal support channel of the central support 132 (e.g., through the support outlets 134, etc.). Stated another way, the blades 136 can be located on the sidewall 116 of the accelerator housing 110 pointing inwards, and the housing outlet(s) 122 may instead be located on along the central support 132.

In one embodiment, the accelerator housing 110, the accelerator 130, the driver 150, the fluid 190, the conduit assembly 200, and the generator 230 are configured (e.g., sized, designed, selected, arranged, etc.) such that there are minimal energy consumption needs to keep the fluid 190 at an elevated speed once brought up to the elevated speed. The energy generated by the generator 230 may therefore provide a net energy gain and be stored by the battery storage 240, used to power the driver 150, used to power external electrical systems, and/or transmitted to the grid. In another embodiment, the generator 230 is used to recapture at least a portion of the energy consumed by the driver 150 to bring the fluid 190 up to the elevated speed and maintain the fluid 190 at the elevated speed, thereby reducing the amount of energy consumed by the fluid acceleration system 10 as a whole. Such a system may be used to perform a mixing process, a centrifuge process (e.g., to separate components of the fluid 190, etc.), or other process on the fluid 190.

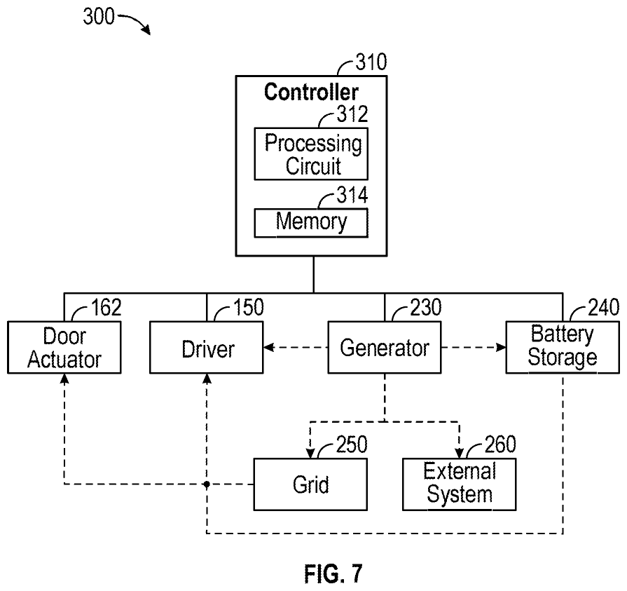

As shown in FIG. 7, the fluid acceleration system 10 includes a control system 300. According to the exemplary embodiment shown in FIG. 7, the control system 300 includes a controller 310. In one embodiment, the controller 310 is configured to selectively engage, selectively disengage, control, or otherwise communicate with components of the fluid acceleration system 10. As shown in FIG. 7, the controller 310 is coupled to (e.g., communicably coupled to) components of the fluid acceleration system 10 including the driver 150, a door actuator 162 (e.g., an electric actuator, a hydraulic actuator, a pneumatic actuator, etc.), the generator 230, and/or the battery storage 240. In some embodiments, the controller 310 is additionally coupled to blade actuators of the blades 136 and/or a scoop actuator of the fluid scoop 170. By way of example, the controller 310 may send and receive signals (e.g., control signals) with the driver 150, the door actuator 162, the generator 230, the battery storage 240, and/or still other components of the fluid acceleration system 10 (e.g., sensors, the scoop actuator, the blade actuators, etc.).

The controller 310 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 7, the controller 310 includes a processing circuit 312 and a memory 314. The processing circuit 312 may include an ASIC, one or more FPGAs, a DSP, circuits containing one or more processing components, circuitry for supporting a microprocessor, a group of processing components, or other suitable electronic processing components. In some embodiments, the processing circuit 312 is configured to execute computer code stored in the memory 314 to facilitate the activities described herein. The memory 314 may be any volatile or non-volatile computer-readable storage medium capable of storing data or computer code relating to the activities described herein. According to an exemplary embodiment, the memory 314 includes computer code modules (e.g., executable code, object code, source code, script code, machine code, etc.) configured for execution by the processing circuit 312. In some embodiments, the controller 310 may represent a collection of processing devices (e.g., servers, data centers, etc.). In such cases, the processing circuit 312 represents the collective processors of the devices, and the memory 314 represents the collective storage devices of the devices.

According to an exemplary embodiment, the controller 310 is configured to initiate a start-up operation of the fluid acceleration system 10. As part of the start-up operation, the controller 310 is configured to operate the driver 150 to drive the accelerator 130 to accelerate the fluid 190 within the fluid acceleration chamber 118. In some embodiments, the controller 310 is configured to engage the door actuator 162 to close the outlet door 160 during the start-up operation. In other embodiments, the controller 310 is configured to engage the door actuator 162 to open the outlet door 160 during the start-up operation. The battery storage 240 may power the driver 150 during the start-up operation (e.g., if the driver 150 is or includes an electric motor, etc.). If the state-of-charge of the battery storage 240 is insufficient, the driver 150 may be powered from the grid 250 or other electrical power source (e.g., if the driver 150 is or includes an electric motor, etc.).

According to an exemplary embodiment, the controller 310 is configured to monitor the speed of the accelerator 130 and/or the fluid 190 within the fluid acceleration chamber 118 (e.g., via one or more speed sensors, rotation sensors, flow sensors, etc.). The controller 310 may be configured to switch from the start-up operation to steady-state operation in response to the speed of the accelerator 130 and/or the fluid 190 reaching a target speed threshold (e.g., monitored using a speed sensor, etc.). As part of the steady-state operation, the controller 310 may be configured to operate the driver 150 as is only necessary to maintain the speed, but not increase the speed, and allow the momentum of the fluid 190 to substantially maintain the speed within the fluid acceleration chamber 118, thereby limiting the load on the driver 150 and the energy consumed thereby.

The controller 310 may be further configured to engage the door actuator 162 to open the outlet door 160 to divert a portion of the fluid 190 from the fluid acceleration chamber 118 into the exhaust conduit 210 to interact with the generator 230 to generate electricity (e.g., when the steady-state operation is achieved, etc.). Therefore, the controller 310 may be configured to monitor the speed of the fluid 190 in the fluid acceleration chamber 118 with sensors, and when the fluid 190 is sufficiently accelerated, open the outlet door 160 via the door actuator 162 to begin the energy generation process. In one embodiment, the controller 310 is configured to maintain the outlet door 160 in an open position so long as the speed of the accelerator 130 and/or the fluid 190 within the fluid acceleration chamber 118 can be substantially maintained. In another embodiment, the controller 310 is configured to control the door actuator 162 to open and close the outlet door 160 periodically.

The controller 310 may be further configured to reposition the fluid scoop 170 via the scoop actuator so the fluid scoop 170 extends from the sidewall 116 of the accelerator housing 110 when the accelerator 130 and/or the fluid 190 within the fluid acceleration chamber 118 is at and/or above the target speed threshold. For example, fluid scoop 170 may be in a retracted position during start-up operations, and the controller 310 may be configured to move fluid scoop 170 to an extended, inward position as part of the steady-state operations.

The energy generated by the generator 230 may be used to operate the driver 150 (e.g., if the driver 150 is an electric motor, etc.), the door actuator 162 (e.g., if the door actuator 162 is an electrically operated actuator, etc.), the blade actuators, and/or the scoop actuator. The energy generated by the generator 230 may additionally or alternatively be used to charge the battery storage 240 (which may then be used to power the driver 150 and/or power the door actuator 162). The energy generated by the generator 230 may additionally or alternatively be used to power one or more external systems 260 coupled to the fluid acceleration system 10 (e.g., electrically operated systems or devices local to or proximate the fluid acceleration system 10, etc.). The energy generated by the generator 230 may additionally or alternatively be transmitted to the grid 250 and/or sold to a utility or consumer(s).

In some embodiments, the controller 310 is configured to control the blade actuators of the blades 136 to adjust the size and/or the orientation of the blades 136. In some embodiments, the controller 310 is configured to control the blade actuators to extend or retract the blades 136 to adjust the diameter of the accelerator 130. In some embodiments, the controller 310 is configured to control the blade actuators to adjust the orientation of the blades 136 from a horizontal, flat orientation to an angled or vertical orientation.

While the disclosure herein regarding the controller 310 is only directed to a fluid acceleration system 10 having a single outlet door 160, a single door actuator 162, a single scoop actuator, and a single generator 230, it should be understood that the controller 310 can be applied to systems that include (i) a plurality of outlet doors 160, a plurality of door actuators 162, and/or a plurality of scoop actuators (e.g., systems that include a plurality of housing outlets 122, etc.) and/or (ii) a plurality of generators 230.

According to an exemplary embodiment, the controller 310 is configured to control a plurality of drivers 150. The controller 310 may be configured to operate the drivers 150 in a sequence or in series corresponding to the properties of the blades 136 controlled by each driver 150. By way of example, a first driver 150 may be connected to a first group of the blades 136 that are smaller relative to another group of blades 136 connected to a second driver 150. The controller 310 may be configured to operate the drivers 150 to accelerate in sequence, rotating the group of smaller blades 136 first, and only rotating the second group of larger blades 136 after the accelerator 130 reaches a certain speed. In some embodiments, there are multiple (e.g., 2, 5, 10, 15, 20, etc.) groups of blades 136 of various sizes and/or shapes controlled independently by discrete drivers 150. In other embodiments, a single driver 150 switches between the different groups of blades 136, In some embodiments, two groups of blades 136 may rotate at least partially at the same time within the fluid acceleration chamber 118.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Language such as the phrases “at least one of X, Y, and Z” and “at least one of X, Y, or Z,” unless specifically stated otherwise, is understood to convey that an element may be either X; Y; Z; X and Y; X and Z; Y and Z; or X, Y, and Z (i.e., any combination of X, Y, and Z). Thus, such language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the fluid acceleration system 10 and components thereof as shown in the various exemplary embodiments is illustrative only. Additionally, any element disclosed in one embodiment may be incorporated or utilized with any other embodiment disclosed herein.

1. A fluid acceleration system comprising:
a housing defining an inlet, an outlet, and an interior chamber configured to receive a fluid;
a rotational element disposed within the interior chamber, the rotational element including:
a central support extending between an upper wall and a lower wall of the housing; and
a plurality of blades coupled to the central support;
a conduit assembly positioned external to the housing, the conduit assembly connecting the outlet to the inlet; and
a driver positioned to drive the rotational element to accelerate the fluid within the interior chamber such that a portion of the fluid flows out of the outlet, through the conduit assembly, and back into the interior chamber through the inlet.

2. The fluid acceleration system of claim 1, wherein the housing defines a plurality of inlets connected to the conduit assembly.

3. The fluid acceleration system of claim 1, wherein the central support aligns with the inlet and defines an internal support channel that receives the fluid from the conduit assembly.

4. The fluid acceleration system of claim 3, wherein the central support defines a support aperture configured to release the fluid into the interior chamber.

5. The fluid acceleration system of claim 4, wherein the central support defines a plurality of support apertures.

6. The fluid acceleration system of claim 5, wherein the plurality of apertures are positioned proximate one end of the central support.

7. The fluid acceleration system of claim 5, wherein the plurality of apertures are spaced along at least a portion of a length of the central support.

8. The fluid acceleration system of claim 3, wherein at least one of the plurality of blades defines an internal blade channel that receives the fluid from the internal support channel of the central support, and wherein the at least one of the plurality of blades defines a blade aperture this is configured to release the fluid into the interior chamber.

9. The fluid acceleration system of claim 8, wherein the blade aperture is positioned proximate a free end of the at least one of the plurality of blades.

10. The fluid acceleration system of claim 8, wherein the blade aperture is positioned proximate a connection between the central support and the at least one of the plurality of blades.

11. The fluid acceleration system of claim 8, wherein the at least one of the plurality of blades defines a plurality of blade apertures.

12. The fluid acceleration system of claim 1, wherein the central support has a cylindrical shape.

13. The fluid acceleration system of claim 1, wherein the central support has a conical shape.

14. The fluid acceleration system of claim 1, wherein the central support and the plurality of blades have a spiral structure or a helical structure.

15. The fluid acceleration system of claim 1, further comprising a door positioned to selectively close the outlet of the housing.

16. The fluid acceleration system of claim 1, further comprising a fluid scoop coupled to the housing proximate the outlet, the fluid scoop positioned to direct the portion of the fluid from the interior chamber, through the outlet, and into the conduit assembly.

17. The fluid acceleration system of claim 1, further comprising a generator positioned along the conduit assembly and that receives the portion of the fluid.

18. The fluid acceleration system of claim 17, further comprising a battery coupled to the generator.
